(19) United States
(12) Patent Application Publication
(10) Pub. No.: US 2012/0029806 A1
(43) Pub. Date: Feb. 2, 2012

(54) Efficient Navigation Data Downloading

(75) Inventors: Mark Scalf, Santa Clara, CA (US); Mark Schunder, Dearborn, MI (US); Joseph J. Berry, Northville, MI (US)

(73) Assignee: FORD GLOBAL TECHNOLOGIES, LLC, Dearborn, MI (US)

(21) Appl. No.: 12/847,659

(22) Filed: Jul. 30, 2010

(51) Int. Cl. G01C 21/00; G06F 15/16

(52) U.S. Cl. 701/201; 709/231

(57) ABSTRACT

A packetization method includes preparing data comprising driving instructions for delivery to a vehicle. The illustrative method also includes determining a portion of the data to deliver in a first packet to a vehicle computing system in communication with a server executing the method, based at least in part on when the first packet, containing at least a first driver action instruction, is needed in the vehicle. The method further includes adding the determined portion of data to the packet and delivering the first packet of data to a vehicle computing system in communication with the server. Finally, the method includes repeating the steps of determining, adding and delivering, until no data remains for delivery, such that packets arrive at a vehicle and are processed for output prior to a first driver action instruction of each packet being needed in the vehicle, the repetition contingent on data remaining for delivery.

### BACKGROUND AND SUMMARY

Vehicle navigations systems, such as on-board systems and portable GPS systems, have been available for some years now. Originally, these systems would often receive map information from removable media, such as a CD. More recently, many of the map systems have an internal memory storing map information.

Although some systems store maps on local memory, such as a hard disk drive (HDD), other systems may contact a remote network to receive mapping information. This information, for example, may be a series of directions delivered over a wireless connection. In instances such as this, where map data is not stored (or only partially stored) on a local HDD, a provider may be constrained by, for example, bandwidth limitations in how quickly the data can be delivered.

In at least one existing system, the Ford SYNC system, a vehicle computing system (which may contain or is in communication with a vehicle navigation system, either on or off-board) may connect to a remote network using voice over IP (VOIP). This connection is a limited bandwidth connection employing the voice-band of a wireless device connected to the vehicle computing system and a remote network.

Because the voice-band has a limited available bandwidth, information is capped at a low delivery speed (relative to, for example, a pure data connection). While this normally may not affect a need-for-data scenario, because the user can wait, in some instances this can be somewhat problematic, as in the case of a user in a moving vehicle requesting directions. If the requested directions cannot be delivered in an efficient manner over the available bandwidth, then the user may actually pass a first or even a second turn on a route before the directions are delivered to the vehicle (due, for example, to a large file being delivered over a low bandwidth connection).

In a first illustrative embodiment, a method includes preparing data comprising driving instructions for delivery to a vehicle (e.g., without limitation, determining a route, determining instruction points along a route, etc.).

The illustrative method also includes determining a portion of the data to deliver in a first packet to a vehicle computing system in communication with a server executing the method, based at least in part on when the first packet, containing at least a first driver action instruction, is needed in the vehicle.

The method further includes adding the determined portion of data to the packet and delivering the first packet of data to a vehicle computing system in communication with the server.

The method also includes repeating the steps of determining, adding and delivering, until no data remains for delivery, such that packets arrive at a vehicle and are processed for output prior to a first driver action instruction of each packet being needed in the vehicle, the repetition contingent on data remaining for delivery.

A second illustrative embodiment includes a computer-readable storage medium storing instructions that, when executed, cause a server to prepare data comprising driving instructions for delivery to a vehicle. Determine a portion of the data to deliver in a first packet to a vehicle computing system in communication with a server, the determination based at least in part on when the first packet, containing at least a first driver action instruction, is needed in the vehicle.

The server also adds the determined portion of data to the packet and deliver the first packet of data to a vehicle computing system in communication with the server.

Finally, the server may repeat the steps of determining, adding and delivering, until no data remains for delivery, such that packets arrive at a vehicle and are processed for output prior to a first driver action instruction of each packet being needed in the vehicle, the repeating contingent on data remaining for delivery.

One illustrative apparatus includes data preparing programmed logic circuitry to prepare data comprising driving instructions for delivery to a vehicle. The exemplary apparatus also includes determining programmed logic circuitry to determine a portion of the data to deliver in a first packet to a vehicle computing system in communication with a server, based at least in part on when the first packet, containing at least a first driver action instruction, is needed in the vehicle.

The apparatus further includes adding programmed logic circuitry to add the determined portion of data to the packet and delivering programmed logic circuitry to deliver the first packet of data to a vehicle computing system in communication with the server.

Finally, the apparatus includes repeating program logic circuitry to repeat calls to the of determining, adding and delivering programmed logic circuitry, until no data remains for delivery, such that packets arrive at a vehicle and are processed for output prior to a first driver action instruction of each packet being needed in the vehicle. This repetition is, contingent on data remaining for delivery.

### BRIEF DESCRIPTION OF THE DRAWINGS

FIG. 1 illustrates an example block topology for a vehicle based computing system;

FIG. 2 shows an illustrative example of a process for breaking a route plan into a plurality of packets;

FIG. 3 shows an illustrative example of a process for determining whether a packet is ready for delivery;

FIG. 4 shows an illustrative example of a time threshold determination process;

FIG. 5 shows an illustrative example of a vehicle reaching different locations along a route based on speed of travel and exit options; and

FIG. 6 shows an illustrative example of calculating a vehicle's projected position and an amount of data to be included.

### DETAILED DESCRIPTION

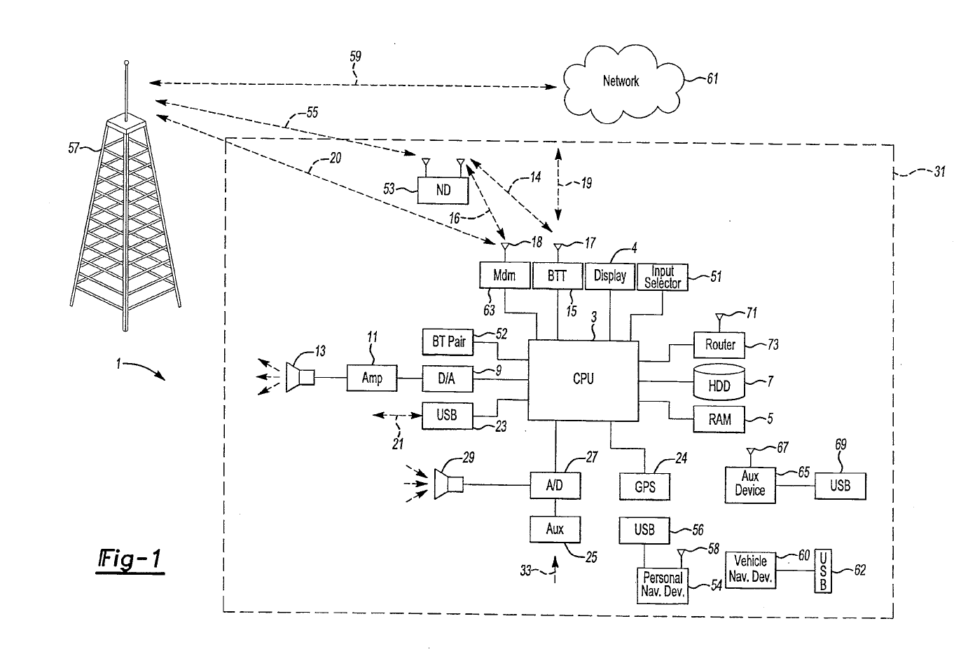

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broadband transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73. Auxiliary device 65 may include, but are not limited to, personal media players, wireless health devices, portable computers, and the like.

In at least one exemplary system for route determination and delivery, a vehicle computing system receives route instructions from a remote system. In this embodiment, the actual route may be calculated off-board the vehicle system and delivered to the vehicle computing system via a wireless connection through a wireless device. Because the bandwidth may be constrained by the connection through the wireless device, it may be desirable to deliver the information in several pieces. This allows the initial information (e.g., the information needed to make an immediately upcoming turn) to be delivered rapidly and the remaining information to be delivered in a timely, but not immediate, manner.

For example, without limitation, it may take several seconds to process and return a direction request. If the entire request were processed and returned, in some instances, this delay could be multiple tens of seconds. While this may seem to be a rather insignificant amount of time, a driver traveling at fifty miles an hour can pass eleven side streets that are two hundred feet apart in thirty seconds. Thus, especially with respect to the initial turn (or first few turns), it is desirable to deliver the direction information swiftly enough that it is useful to a moving driver.

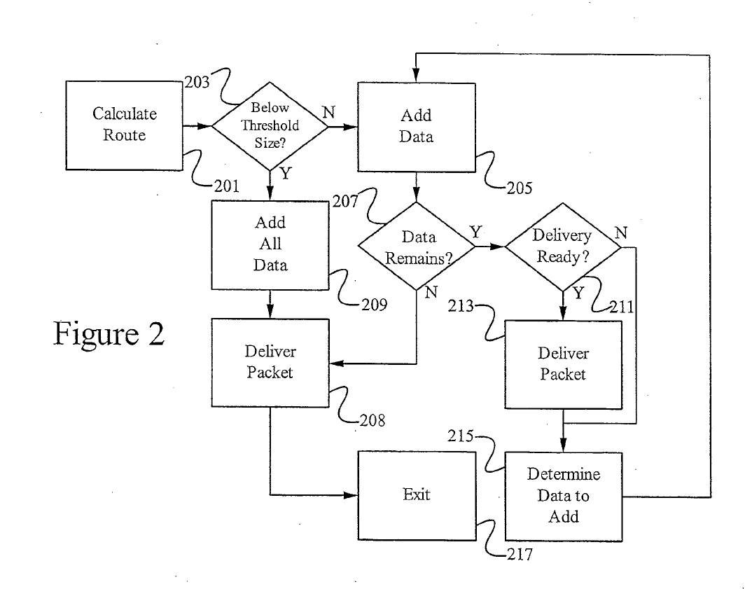

In the illustrative example shown with respect to FIG. 2, an off-board system calculates a route to be traveled 201. Any suitable process for calculating a route from a current location to a destination may be implemented.

Once the route to be traveled has been calculated, the system includes a first data set in the first packet 205. In this illustrative embodiment, the first data set is data up to, and including, a first instruction (i.e., the point where a driver needs to react to the data).

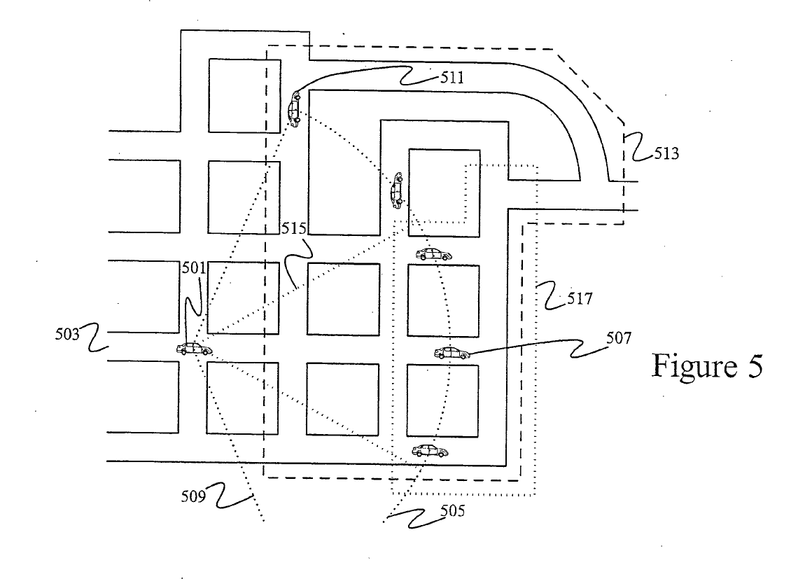

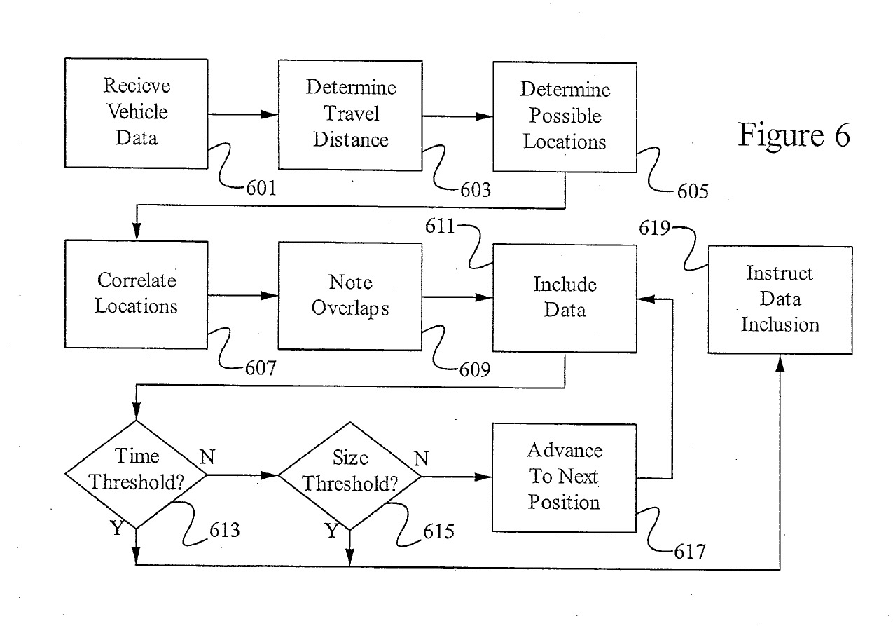

The routing engine determines all of, or at least a first portion of, a route to be traveled and determines at what point a vehicle is likely to reach a first instruction point based at least in part on current speed, heading, and location (as provided, for example, when the route is requested). An exemplary process for estimating vehicle location is shown with respect to FIGS. 5 and 6 described in further detail below. In some embodiments, since the vehicle may be moving while the request, calculation and subsequent delivery is taking place, the packetization process may account for possible vehicle movement during the time the request is pending.

If only enough data to fill the first packet exists 207 (i.e., no data remains after the initial inclusion of data), all the directions may be delivered in a single packet. Additionally, if the entire set of directions is below a certain size threshold 203 (thus indicating, for example, that the directions can be delivered in a rapid, single transmission), then the system may include all the data in a single packet 209. This first packet may then be delivered to a vehicle computing system 208.

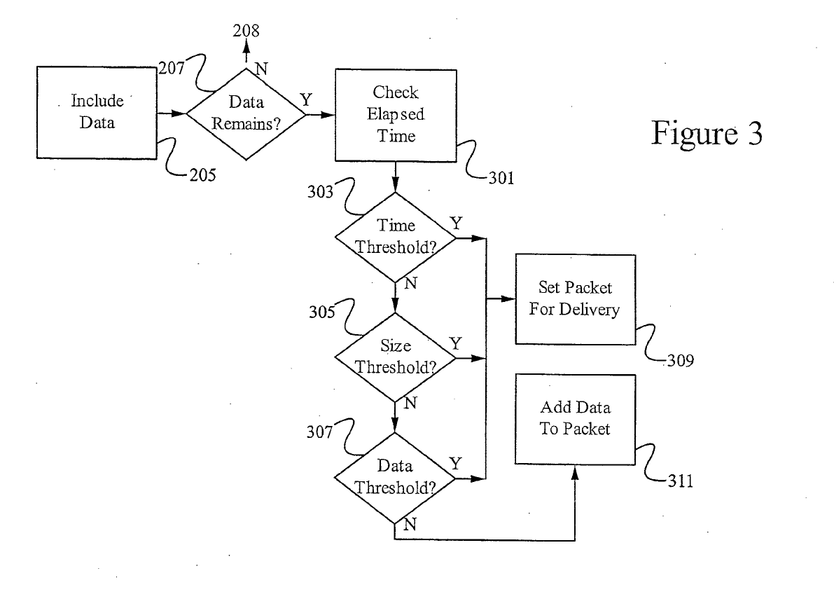

If data remains that has not yet been added to the packet for delivery 207, the system determines whether or not the first packet is ready for delivery 211. This determination is described in more detail with respect to FIG. 3.

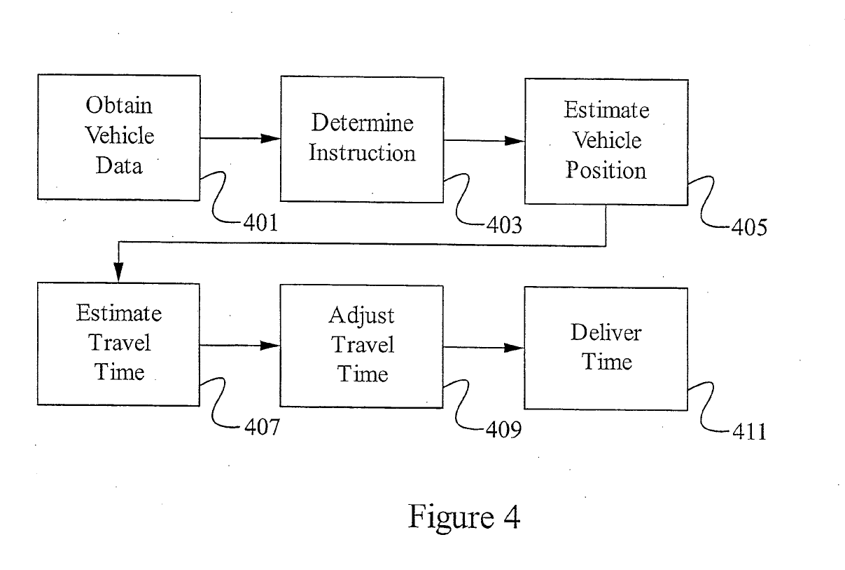

If the packet is ready for delivery, the packet is delivered 213 to the vehicle computing system. The illustrative process then determines at least a portion of the remaining data to be added to a next packet 215. This determination is described in more detail with respect to FIG. 4.

If an additional packet is needed to complete delivery of the directions, the process of determining which data to add to a packet may be repeated. This process may continue producing packets until no instructions remain for delivery, at which point the process may exit 217.

In at least one exemplary embodiment, a first and second packet (if needed) include data up to, but no more than, three turns each, and all the remaining data, if any, is provided in a third and final packet. Although not intended as a limiting example, it has been determined that this configuration is suitable for a variety of driving scenarios and will typically result in delivery of directions within a requisite time threshold. If a particular route is beyond a certain length, for example, or is taking too long to process, the first packet may be delivered before the entire route is finished being calculated.

FIG. 3 shows an illustrative example of a process for determining whether a packet is ready for delivery.

In this illustrative example, after at least one instruction has been included with a packet 205, and data still remains 207, the system checks to determine how much time has elapsed since the route request was initiated 301. If the elapsed time is above a threshold time 303, the system sets the first packet for delivery 309. Additionally, the system checks to see if a maximum packet size 305 has been reached, or if a maximum amount of data 307 (for example, in terms of directions) has been included with a particular packet. These tests are merely exemplary tests for determining whether or not a packet is ready for delivery. One or more of these tests may be omitted, or other tests may be additionally or alternatively used as needed.

In this embodiment, the system has included a time check due to the interplay between a desire for prompt delivery and the impact of processing time. Since the off-board system may take some finite amount of time to calculate and/or deliver the driving instructions, and because the driver may currently be in motion, a long delay in delivering instructions may cause a driver to miss a first turn.

Although not shown with respect to this embodiment, the system may further determine, based on the distance a vehicle is required to travel along a current road and a received vehicle speed (or a projected vehicle speed), the time allowed for further processing. For example, without limitation, if a vehicle is to travel ten miles along a current road, and the road has an estimated speed of thirty miles per hour, then the system may determine that a first turn instruction is not needed for a number of minutes. Additionally or alternatively, a predetermined time threshold may be set, either to ensure that too long a delay does not occur before delivery of instructions or that a determined time does not exceed a maximum time for delivery (which may result in a driver mistakenly believing that a direction request was not processed). An example of a time threshold calculation process is shown with respect to FIG. 4.

If a maximum packet size has been reached 305, the system will also set the packet for delivery 309. Even if a driver has minutes or hours before a first instruction needs to be delivered (i.e., the driver has to react), it may be desirable to ensure that a first packet reaches the driver within a finite amount of time. Based on bandwidth constraints and the amount of time desired, limiting at least the initial packet size may ensure swift delivery of at least a portion of the route, so the driver knows the request has been received.

Depending on the particular implementation, the determination of a “maximum number of instructions” may result in data of varying size. As described with respect to FIGS. 5 and 6, the system may calculate possible vehicle locations prior to a first likely turn, and include data relating to these locations. Thus, a vehicle traveling swiftly on a road with numerous options for exiting may have a larger data set associated with a first turn than a vehicle traveling slowly or a vehicle on a road with few or no exits prior to an anticipated turn.

In at least one illustrative embodiment, the system caps the number of directions included in at least a first packet at a predefined threshold (such as, but not limited to, two or three). By capping the included number of directions at a low number, it is likely that the first packet will be delivered quickly, thus providing the driver with at least a first set of turns soon after the direction request was made. If the maximum number of instructions has been reached for a particular packet 307, the system flags the packet for delivery 309.

If none of the desired thresholds have been reached, the system instructs the addition of more data to a packet 311.

FIG. 4 shows an illustrative example of a time threshold determination process.

In this illustrative embodiment, a packetization process is provided with a vehicle speed, heading and current location 401 when a route is requested. For example, a route may be requested while a vehicle is traveling through a suburban neighborhood at twenty five miles per hour.

After receiving the data for the vehicle location, the process determines where a first instruction is likely needed 403. This could be a turn instruction, an exit instruction, a veer instruction, etc. Since the vehicle may change locations after the request is sent to the server, the system may have to “guess” at where a turn, for example, is needed. In this illustrative embodiment, although the process is not limited to this example, the guess will be based on when an instruction is needed if the vehicle continues along the present road in approximately the present heading at approximately the present speed.

Exceptions to this “guess” exist, of course, for example, if the vehicle is requesting directions to a destination in an opposite direction of a current heading. These exceptions can be handled on a case by case basis, or the system could implement a different, suitable method of “guessing.”

Once the process knows when a turn will be needed, the process can estimate a current vehicle position 405. This estimation, again, can be based on the data received in 401. Although not infallible, it may be desirable to use a current speed, heading and road-of-travel because this data is likely to result in the “worst case” estimation. In other words, if the vehicle has turned off of the road it was traveling on when the directions were requests, the turning likely involved some slowing of the vehicle, and thus any point reached after a turn is made is likely to be further from a first instruction point than if the vehicle had stayed on the same road. Accordingly, in this embodiment the system “guesses” at a vehicle location based on the vehicle continuing along the present road in approximately the present heading at approximately the present speed.

Of course, traffic and speed limit changes on alternate routes could cause the “present route” guess to be less than optimal, but in many cases it will suffice as an adequate approximation covering most likely vehicle locations.

Once the likely vehicle location is known and a likely point of a first instruction is known, the system can estimate how long it should take for the vehicle to reach a the point of first instruction 407. Since a location, heading and speed of the vehicle has been approximated, based on known data, the system can use this information to see how much travel time remains prior to the point of instruction.

This remaining time can then be adjusted 409 as needed. In this illustrative example, a predetermined amount of processing and delivery time is subtracted from the remaining travel time, and an estimate of time remaining before the instruction needs to be delivered is obtained. In this embodiment, it is also desired not to deliver the instruction to the driver as the turn is needed (e.g. “turn NOW”), so an additional reaction time is subtracted. The calculated time can be fixedly or dynamically adjusted as appropriate for a given system.

Once the adjusted travel time is obtained 409, the system delivers the time 411 to a process requesting the time. That process can then use the travel time to perform further determinations, such as, but not limited to, determining when a packet should be delivered.

FIG. 5 shows an illustrative example of a vehicle reaching different locations along a route based on speed of travel and exit options.

In this illustrative example, vehicle 501 is currently traveling on street 503 in an eastward direction. The vehicle's speed in this example is roughly three blocks per minute. The blocks/minute speed classification is used for exemplary purposes and ease of explanation and should not be considered non-limiting. A suitable measurement standard, such as, but not limited to, mph or Kmph could be used in implementation.

As can be seen from the dotted circle 505 and the vehicle outlines 507, the vehicle could reach a variety of locations within one minute. In this embodiment, possible locations are estimated within a 120 degree arc 509 based on the current heading, but the system could estimate locations anywhere within a full 360 degree arc if desired.

Road 509 is the “next” road in the direction set, although, as can be noted from the drawing, if the vehicle is in position 511, different turn instructions may be needed once the directions are output to the driver. Accordingly, in this example, an amount of data 513 is delivered such that the driver is able to reach the determined route from any of the projected locations. This will aid in preventing a need to resend a direction request to the server based on an off-map condition. If insufficient data were included, the user's off-map condition could be exacerbated, as the user, if extremely unfortunate, could continue to make the wrong decision about a direction in which to travel, and continue to perpetuate an off-map condition. If a sufficient amount of data is provided to cover all likely vehicle positions at time of data delivery, than in most cases the user will be able to receive appropriate instructions from the user's present location to the route to be traveled.

The need for sufficient data delivery, however, is balanced with a potential need for swift delivery. If a user requests directions just prior to an upcoming turn (along a determined route), for example, the system may have to deliver the directions before all the data for every possible location can be included. In one embodiment, this is addressed by first including data for the current road/speed/heading, and then including as much data as possible 517 for an arc 515 expanding out from the vehicle's present heading.

Other suitable implementation strategies may also or alternatively be employed, such as, but not limited to, calculating a route based on a minimum travel time from when an instruction is received. For example, the user may be expected to travel for a minimum time before an instruction is received, and the route determination will take this minimum travel time into account when determining a suitable route. This too can have problems, especially if a user passes a swiftly upcoming exit on a highway and the next exit is not for twenty miles. The system may have certain situational triggers built in to address problematic situations. On the other hand, since, in the preceding example, no options for exit except the one exit exist, the system may return the instruction swiftly in any event, since there are no additional “projected” locations for the vehicle (i.e., either the vehicle stays on the highway or “accidentally” exits at the appropriate point prior to receiving the instruction).

FIG. 6 shows an illustrative example of calculating a vehicle's projected position and an amount of data to be included.

In this illustrative embodiment, a vehicle's current location, heading and speed are received by a process 601. The system then determines how far a vehicle can travel within a given period of time, based on this data 603. In this relatively simple example, the system assumes that the vehicle can travel in any linear direction for purposes of estimation. That is, it does not take into account likely slowing when the vehicle turns, etc. A more sophisticated system considering factors such as, but not limited to, slowing, speed limit changes, stop signs, traffic lights, traffic patterns, etc. could be implemented, although the more complex the “guessing” algorithm the longer it would likely take to process.

Once an estimated distance of travel is obtained 603, this distance is translated to a plurality of possible vehicle locations 605. The locations are then correlated with map data 607, and points where the projected locations overlap the roads within the desired arc are noted 609.

Once the system has the projected points of location within the desired arc, it determines data to be included based on those locations. In this embodiment, a relatively simple data inclusion process is given as an example, although more complex algorithms could also be used as suitable.

In this embodiment, a first position is considered with respect to a current (as received) heading. Data from that position to a first turn (or other instruction) is included 611. If a time 613 or size 615 threshold has not been met, the system then advances to a next position 617 and includes data relating to that position 611.

In one illustrative embodiment, the process systematically considers positions above and below a center (current) heading until a maximum arc is reached (or a time or size threshold is met). In this embodiment, the system starts with above or below center position, based on which direction an upcoming turn is to be made. For example, if the vehicle is traveling east, and the upcoming turn is a right turn (sending the vehicle south), the first check would be south of east. The next check would be a similar distance north of east, and this would repeat until one of the ending conditions has been met.

Alternatively, the system could check all points south of east (since this is the desired eventual direction) before checking any points north of east. Or the opposite could also be done.

These strategies are designed to provide a desired data set if a time/size threshold is met before an entire arc is checked. Accordingly, any algorithm providing a reasonable result in accordance with a provider's desires is suitable for implementation.

Once a predetermined end point has been met, the system provides instruction as to what data is to be included 619.

While various exemplary, illustrative, non-limiting embodiments have been described in detail, those familiar with the art to which this invention relates will recognize various alternative designs and embodiments for practicing the invention, which is only limited by the following claims.

What is claimed:

1. A computer-implemented method comprising:
preparing data comprising driving instructions for delivery to a vehicle;
determining a portion of the data to deliver in a first packet to a vehicle computing system in communication with a server executing the method, based at least in part on when the first packet, containing at least a first driver action instruction, is needed in the vehicle;
adding the determined portion of data to the packet;
delivering the first packet of data to a vehicle computing system in communication with the server; and
contingent on data remaining for delivery, repeating the steps of determining, adding and delivering, until no data remains for delivery, such that packets arrive at a vehicle and are processed for output prior to a first driver action instruction of each packet being needed in the vehicle.

2. The method of claim 1, wherein a first driver action instruction is needed in the vehicle at least a predetermined amount of time prior to when the driver is to execute an action instructed by the instruction.

3. The method of claim 2, wherein, after a direction request has been sent to the server, the server is operable to estimate how much time remains before a driver must execute the first action.

4. The method of claim 3, wherein the server is operable to estimate how much time remains before a driver must execute the action, based at least in part on a current heading, speed and position of the vehicle

5. The method of claim 1, wherein a first driver action instruction is needed in the vehicle at least a predetermined distance prior to when the driver is to execute the action instructed by the instruction.

6. The method of claim 5, wherein, after a direction request has been sent to the server, the server is operable to estimate how much distance remains before a driver must execute the first action.

7. The method of claim 6, wherein the server is operable to estimate how much distance remains before a driver must execute the action, based at least in part on a current heading, speed and position of the vehicle

8. The method of claim 1, using no more than three packets, wherein a third packet contains all data not presented in a first two packets, contingent on the third packet being used.

9. The method of claim 1, wherein a first packet contains no more than three driver action instructions.

10. The method of claim 5, wherein a second packet contains no more than three driver action instructions.

11. The method of claim 1, wherein the server continues to add data to each packet being processed until a predetermined time before when the packet is needed by the driver.

12. A computer-readable storage medium storing instructions that, when executed, cause a server to perform the steps of:
preparing data comprising driving instructions for delivery to a vehicle;
determining a portion of the data to deliver in a first packet to a vehicle computing system in communication with a server, based at least in part on when the first packet, containing at least a first driver action instruction, is needed in the vehicle;
adding the determined portion of data to the packet;
delivering the first packet of data to a vehicle computing system in communication with the server; and
contingent on data remaining for delivery, repeating the steps of determining, adding and delivering, until no data remains for delivery, such that packets arrive at a vehicle and are processed for output prior to a first driver action instruction of each packet being needed in the vehicle.

13. The method of claim 12, wherein a first driver action instruction is needed in the vehicle at least a predetermined amount of time prior to when the driver is to execute an action instructed by the instruction.

14. The method of claim 12, using no more than three packets, wherein a third packet contains all data not presented in a first two packets, contingent on the third packet being used.

15. The method of claim 12, wherein a first packet contains no more than three driver action instructions.

16. The method of claim 15, wherein a second packet contains no more than three driver action instructions.

17. An apparatus comprising:
respective programmed logic circuitry for:
preparing driving instruction data;
based on delivery time, determining the data to deliver in a first packet having a driver action instruction to a vehicle computer communicating with a server;
adding data to the packet;
delivering the first packet; and
contingent on data remaining for delivery, repeating calls until none remain, wherein packets are processed for output in the vehicle before a driver action instruction is needed.

18. The apparatus of claim 17, wherein a first driver action instruction is needed in the vehicle at least a predetermined amount of time prior to when the driver is to execute an action instructed by the instruction.

19. The apparatus of claim 17, using no more than three packets, wherein a third packet contains all data not presented in a first two packets, contingent on the third packet being used.

20. The apparatus of claim 17, wherein a first packet contains no more than three driver action instructions.
